(19) United States
(12) Patent Application Publication
(10) Pub. No.: US 2014/0373934 A1
(43) Pub. Date: Dec. 25, 2014

(54) ATTACHMENT FOR FLOAT VALVE AND METHOD OF USE

(71) Applicant: Jobe Holdings Limited, Matamata (NZ)

(72) Inventors: David Alfred Jobe, Matamata (NZ); Robin James Jobe, Matamata (NZ)

(73) Assignee: Jobe Holdings Limited, Matamata (NZ)

(21) Appl. No.: 14/307,542

(22) Filed: Jun. 18, 2014

(30) Foreign Application Priority Data
Jun. 20, 2013 (NZ) 612266
May 29, 2014 (NZ) 625702

(51) Int. Cl. F16K 31/20

(52) U.S. Cl. CPC F16K 31/20
USPC 137/15.26; 137/430

(57) ABSTRACT

An attachment for a float valve may permit a larger flow of water than conventional float valves. A second outlet of the attachment may be dimensioned such that a greater amount of water is able to exit it than through an outlet of the float valve. This helps replenish the trough at a greater flow rate than what is possible through the use of the float valve alone.

### CROSS REFERENCE TO RELATED APPLICATIONS

This application claims the benefit of New Zealand Provisional Patent Application No. 612266, filed on Jun. 20, 2013, and New Zealand Patent Application No. 625702, filed on May 29, 2014. The subject matter of these earlier filed patent applications is hereby incorporated by reference in its entirety.

### FIELD

The present invention generally relates to valves, and more particularly, to an attachment for a float valve. Embodiments of the present invention may have particular application for use with a float valve in a trough for drinking water. However, this is not meant to be limiting and use of the invention with other types of fluids and containers is envisaged without deviating from the scope of the invention.

### BACKGROUND

A float valve, which may also be known as a ball cock, trough valve or ball valve, is commonly used to control the inflow of fluid into an open or closed container. As fluid is depleted, the float valve acts to allow replacement fluid into the container.

In its simplest form, a float valve consists of a buoyant float or ball cock, linked to an arm, positioned within the container. The float is buoyant and thus floats on the surface of the fluid. A surface of the float seals a fluid inlet into the container (in more complex arrangements, the ball cock may be provided with a linkage assembly, the end of which is configured to be operable on the fluid inlet). As fluid levels within the container decrease, the float falls away from the inlet. This allows fluid to enter the container, thus restoring the fluid levels.

When a predetermined fluid level is reached, the float will bias or otherwise act against the fluid inlet. This seals it and prevents further fluid from entering the container. Thus, the container is prevented from overflowing.

One example of a use for a float valve is in animal husbandry, when an open container such as a trough is provided for drinking water. Water is a valuable resource and wastage is to be avoided, particularly in dry environmental conditions. Therefore, it is important to control water flow into drinking troughs to avoid overflow.

However, in some instances, the water is consumed at a rate that is greater than it is able to be replenished.

A disadvantage of float valves is that the replenishment rate is determined largely by the dimensions of the fluid inlet into the trough. For a float valve to be effective, the fluid inlet must be small enough to be sealed by the float itself. Essentially, this means that when a trough fitted with a float valve is being refilled, the rate of water passing through the fluid inlet into the trough is not much more than a trickle.

When a herd of cattle descends on a trough, for example when returning from a milking session, the water can be quickly consumed. Because of the slow rate at which the trough is refilled, it can take some time before it is fully replenished. This can leave some animals, which were unable gain access to the trough in time, to become dehydrated and overly stressed. This can have consequences for the health and milk production of these animals. Accordingly, an improved float valve system may be beneficial. It is an object of some embodiments of the present invention to address the foregoing problems or at least to provide the public with a useful choice. Further aspects and advantages of the present invention will become apparent from the ensuing description which is given by way of example only.

### SUMMARY

Certain embodiments of the present invention may provide solutions to the problems and needs in the art that have not yet been fully identified, appreciated, or solved by current float valve technologies. In some embodiments, an attachment for a float valve may include a body with an upper compartment and a lower compartment, an inlet associated with the upper compartment, a first outlet associated with the lower compartment, and a valve configured to close the inlet. Such embodiments may provide more rapid refilling of a trough, for example, than conventional float valve systems.

In an embodiment, an attachment for a float valve includes a body including an upper compartment and a lower compartment. The attachment also includes an inlet associated with the upper compartment, a first outlet associated with the lower compartment, and a valve configured to close the inlet when used. The first outlet is configured to engage with an inlet of a float valve, and the body includes a second outlet that, when in use, is configured to be sealed by the valve when the valve closes the inlet associated with the upper compartment.

In another embodiment, a method of installing an attachment to a float valve including an inlet includes fitting the attachment to the inlet of the float valve by connecting a first outlet of the attachment to the inlet of the float valve.

In yet another embodiment, a float valve includes a first inlet and an attachment. The attachment includes a body including an upper compartment and a lower compartment. The attachment also includes an inlet associated with the upper compartment, a first outlet associated with the lower compartment, and a valve configured to close the inlet when used. The first outlet is configured to engage with an inlet of a float valve, and the body includes a second outlet that, when in use, is configured to be sealed by the valve when the valve closes the inlet associated with the upper compartment.

In still another embodiment, a kitset of parts for a float valve includes an attachment for a float valve and a float valve. The float valve includes an inlet and the attachment includes a body including an upper compartment and a lower compartment. The attachment also includes a second inlet associated with the upper compartment, a first outlet associated with the lower compartment, and a valve configured to close the second inlet when used. The first outlet is configured to engage with the first inlet, and the body includes a second outlet that, when in use, is configured to be sealed by the valve when the valve closes the second inlet.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a cross sectional side view of an attachment, according to an embodiment of the present invention.

FIG. 2 is a second cross sectional side view of an attachment, according to an embodiment of the present invention.

FIG. 3 is a cross-sectional side view of an attachment in use with a first type of float valve, according to an embodiment of the present invention.

FIG. 4 is a cross-sectional side view of an attachment in use with a second type of float valve, according to an embodiment of the present invention.

### DETAILED DESCRIPTION OF THE EMBODIMENTS

A float valve may include a float disposed within the container that controls a fluid inlet into the container. The float is typically connected to a pivotable arm such that it is able to move in a defined path of travel. The float is buoyant such that it floats upon the fluid within the container. When the fluid level in the container is at its desired maximum, the float operates a sealing mechanism that prevents further fluid flow from the inlet into container. This prevents fluid flow into the container.

When the fluid level decreases through consumption of the fluid, the float, being buoyant, moves with the fluid level. This causes the sealing mechanism to open the fluid inlet, and allows fluid to enter the container. The fluid level within the container will rise until it reaches its maximum and the sealing mechanism becomes operative against the fluid inlet, sealing it and preventing further flow. The sealing mechanism may take a variety of forms depending on the type of float valve.

In its most basic form, the sealing mechanism is a surface of the float that comes into contact with the fluid inlet and seals it. Alternatively, the float has an arm attached to a sealing mechanism that may have a plunger-type action to open and close the fluid inlet. Persons skilled in the art will appreciate that, with minimal or no modifications, some embodiments of the present invention may be used with many types of float valves.

In some embodiments of the present invention, the float valve with which an attachment is to be used is for an outdoor drinking trough, as is found on most farms, and the fluid is water. Reference to this use shall now be made throughout the remainder of this specification. However, this usage is not meant to be limiting and persons or ordinary skill in the art will appreciate that embodiments of the invention may have applications to other usages and fluids. For example, some embodiments the present invention may be readily applied to water storage tanks and cooling towers for manufacturing processes.

Some embodiments include a body. The body should be understood to be a substantially hollow shell. The body may be formed in a number of ways, such as from an upper half and a lower half, bonded, fastened or otherwise secured together along a generally horizontal axis. It should be appreciated that reference to “upper” and “lower” halves is not intended to be limiting, and the body may be divided into two halves split along a substantially vertical axis as opposed to a horizontal axis in certain embodiments. Other two (or potentially more, depending on the body configuration and its manufacturing process) part configurations will be readily envisaged by persons of ordinary skill in the art. Also, it is not beyond the scope of some embodiments of the present invention that the body is provided as a one piece structure, although it will be recognized that this may complicate assembly and manufacture.

In some embodiments of the present invention, the body is formed from plastic material using conventional rotational molding techniques. For example, nylon or fiberglass may be used to form the body. This facilitates ease of manufacture, but it is also possible that the body may be made of metal such as aluminum or brass. However, it will be appreciated that this may have an effect on manufacturing costs.

The body should be understood to have an upper compartment and a lower compartment. In some embodiments of the present invention, the upper compartment is at least partially defined by the upper half of the body, and the lower compartment is at least partially defined by the lower half of the body. It should be appreciated that reference to “upper” and “lower” compartments is not intended to limit the orientation of the compartments with reference to each other or within the body.

An inlet should be understood to be an entry port by which water may enter the body of the attachment. The inlet may take several forms depending on the means by which the water is supplied to the invention. In some embodiments of the present invention, the inlet port is defined at least partially by the upper compartment. In some embodiments of the present invention, the interior of the inlet port may be understood to be the upper compartment.

At least a portion of the inlet may sit proud of the upper half of the body. The inlet may be orientated substantially vertically, such that when in use, water flows downwards through the inlet and into the body. However, in some embodiments, the inlet may be orientated substantially horizontally. It will be appreciated that this may mean that the water supply may have to be slightly pressurized if gravity is insufficient to generate flow. The valve of some embodiments of the present invention may need to be configured accordingly.

In some embodiments of the invention in which an attachment is used with a float valve of a drinking trough, the inlet is configured to receive fittings that typically are provided at the ends of water pipes and hoses. Examples of such fittings include those manufactured by GARDENA®, HOSELINK® or NYLEX®, although these examples are not meant to be limiting.

For export purposes, the inlet may be configured for use with fittings commonly found in the intended country of use. Alternatively, the portion of the exterior surface of the inlet, which sits proud of the body, may be provided with a thread or the like which is complementary to the interior surface of the end of the water supply pipe.

However, in some embodiments of the present invention, the inlet may be a recess in the upper half of the body, into which the end of a water pipe or hose is inserted. The interior surfaces of the inlet may be suitably configured with threads or the like to allow this. The attachment may also include a form of securing mechanism to hold the pipe in place if required.

In some embodiments, at least a portion of the upper compartment is configured as a seat for a valve. This may be simply in the form of a flat ring-like structure depending downwards from the opening of the inlet into the interior of the body.

It will be understood that the inlet supplies water to the upper compartment of the body. The lower compartment of the body is provided with a first outlet for the water. The first outlet should be understood to be an exit port by which the water, having entered the body of the attachment, may exit it.

In some embodiments of the present invention, the first outlet also serves as the means by which the attachment is connected to the float valve. However, it is not beyond the scope of the present invention that the lower half of the body of the attachment is provided with other or additional means by which it is connected to the float valve.

As with the inlet, the first outlet may take several forms that may depend on the configuration of the float valve of which some embodiments of the present invention are to be used. At least a portion of the first outlet may sit proud of the lower half of the body. The first outlet may be orientated substantially vertically, which allows gravity to assist the flow of water. However, in some embodiments, the first outlet may be orientated substantially horizontally.

In some embodiments of the present invention, the first outlet is configured with fittings similar to those manufactured by GARDENA®, HOSELINK® or NYLEX® and which is complementary to similar fittings provided on the inlet of the float valve. For export purposes, the first outlet may be configured for use with fittings commonly found on the inlets of float valves in the intended country of use.

However, in some embodiments of the present invention, the first outlet may be a recess in the lower half of the body, into which the inlet of the float valve is inserted or otherwise located in use. In these embodiments, it will be appreciated that the inlet of the float valve may need to be configured as a protrusion in order to mate with the first outlet. The interior surfaces of the main outlet may be suitably configured with threads or the like to allow this. Persons of ordinary skill in the art will appreciate that a number of complementary and/or interlocking systems may be used to connect the first outlet of the attachment to the inlet of the float valve, and that the examples discussed herein are not meant to be limiting.

The attachment may also include a valve disposed within the body. The valve should be understood to be configured to be responsive to fluid pressure differential above and below the valve. The valve should also be understood to have an upstream side (which faces the upper compartment of the body) and a downstream side (which faces the lower compartment of the body). The valve may also at least partially define the upper and lower compartments of the body.

The valve may include a valve diaphragm and in some embodiments, a hub assembly. In some embodiments, the valve diaphragm is a resilient disc-like structure that, in use, is deformable and thus has a limited range of movement. The disc may be made of a synthetic rubber, although it will be recognized by persons of ordinary skill in the art that other materials may be readily used. This disc shall be referred to as a valve diaphragm throughout the remainder of this specification.

The valve may include a surface that seals against the interior surface of the lower compartment or inlet of the body. It will be appreciated that in some embodiments, the interior surface of the lower compartment acts as a seat for the valve. However, in some embodiments and as previously discussed, the inlet of the body may have a structure depending inwards into the interior of the body that acts as a seat for the valve. It will be appreciated that the sealing of the inlet of the body may be achieved in a number of ways. For example, in some embodiments of the present invention, a surface of the valve diaphragm seals against the interior surface of the body.

In some embodiments of the present invention, the valve may be provided with a hub assembly, about which the valve diaphragm is fitted. In these embodiments, the hub assembly may include a surface that seals against the inlet of the body (or the interior surface of the lower compartment, as the case may be). Thus, the valve diaphragm itself does not act to seal the inlet, but the surface of the hub assembly does.

In such embodiments, it will be appreciated that the hub assembly has a limited range of movement within the interior of the body. This range of movement may be defined by the extent to which the valve diaphragm is able to be deformed. In some embodiments, the outer edges of the valve diaphragm are secured or otherwise anchored to the interior walls of the body. For example, the outer edges of the valve diaphragm may be trapped or otherwise sandwiched between the upper and lower halves of the body. It will be appreciated that this leaves the inner, unanchored, portion of the valve diaphragm able to move in response to changes in fluid pressures.

The hub assembly may include a central shaft passing through the center of the diaphragm valve to provide some control over its range of movement. In some embodiments of the present invention, the interaction of the shaft with the hub assembly may be such that limited water flow from the upstream side of the valve into the lower compartment and downstream out the first outlet is allowed. However, once the lower compartment is full, which may occur when the float valve is sealed, even this flow of water may be prevented.

In some embodiments of the present invention, the hub assembly and/or the valve diaphragm is dimensioned such that it is larger than the interior of the inlet. It will be appreciated that the outer edges of the hub assembly and/or valve diaphragm provide the sealing contact with the inlet.

The body may also include at least a second outlet. The second outlet may be configured so as to discharge water into a trough without having to pass through the float valve to which the attachment, in use, is attached. In some embodiments of the present invention, the second outlet acts as the main conduit for water exiting the body and entering the trough. Water flow through the second outlet is greater than water flow through the first outlet.

It will be appreciated that this means that the second outlet should be dimensioned accordingly such that a greater amount of water will flow through it compared to the first outlet. The actual dimensions of the second outlet will depend on the refill rate desired and the preferences of the user.

When the valve (or its hub assembly) is in sealing contact with the interior surface of the inlet, this prevents water from the upstream side of the valve from exiting the second outlet. It will be appreciated that this means that the water exiting the body has two routes, the first outlet (into the float valve) and the second outlet. However, the valve is configured such that water flow out of the second outlet is only permitted when water is also exiting the first outlet. This provides a means by which the trough with which the embodiment is to be used is more quickly restored to its maximum or desired capacity.

The position of the second outlet relative to the body is such that when the water pressure is greater or equal on the downstream side of the valve relative to the upstream side, the second outlet, and in most cases the first outlet, is sealed. This prevents water flow through the attachment, and therefore no additional water is able to enter the trough (which may otherwise result in it overflowing).

The second outlet may be a hollow tube or the like extending to a side of the body. In some embodiments, the tube is formed as an elbow bend such that water is discharged from the second outlet in a downward direction. However, this is not meant to be limiting and the outlet may simply be a straight or curved tube, depending on the requirements of the user.

In some embodiments of the invention, the second outlet is linked or otherwise associated with the lower compartment. Persons of ordinary skill in the art will appreciate that the internal architecture of the body of the attachment should be suitably configured to achieve this.

In some embodiments of the present invention, the second outlet may be communicative or otherwise associated with the upper compartment, but only when the valve is in an open position. This means that when the valve is open, water flow is permitted through both the first and second outlets. It will be appreciated that in such embodiments, the movement of the valve assembly at least partially occludes the opening of the second outlet into the interior of the body.

In some embodiments of the present invention, there are only two outlets to the attachment, the first outlet, which allows flow of water through the body and into the inlet of the float valve, and the second outlet, which, in some embodiments, bypasses the float valve altogether and allows water flow directly into the trough with which the embodiment is to be used. However, it is not beyond the scope of some embodiments of the present invention that additional outlets, associated with the lower compartment of the body, may also be present. This could be particularly preferred when high refill rates are desired. However, persons of ordinary skill in the art will appreciate that refill rates may also depend on the rate of water supply to the inlet of the attachment.

In a conventional float valve, the water supply is connected directly to the float valve via its inlet. It would then flow through the float valve and out a small outlet into the trough until the ballcock of the float valve rises with the increasing water levels in the trough to seal against the outlet. When using some embodiments of the present invention, the attachment is fitted via its first outlet to the inlet of a float valve of a farm trough, for example. The water supply is then connected to the inlet of the body of the attachment.

When the ballcock cannot seal against the outlet of the float valve because water levels in the trough are low, the pressure of the water supply is greater than the pressure under the valve of the attachment. The valve, or the valve diaphragm, is deformed and cannot seal against the inlet of the attachment. Water is able to pass through the body of the attachment, exiting it directly into the trough via the second outlet as well as through the float valve itself via the first outlet.

When the trough is full, the ballcock of the float valve biases against its outlet. This increases the pressure under the valve within the body of the attachment. The pressure on the downstream side of the valve is greater or equal to that of the pressure on the upstream side of the valve, from which the flow of water originates. This returns the valve to a closed state, sealing off the inlet of the attachment. This prevents further water flow into the body of the attachment and therefore stops the refilling of the trough.

Some embodiments of the present invention offer a number of advantages over conventional valve systems, including easy installation into existing farm drinking troughs that already have a conventional float valve present, easy adaptability for use with existing float valves, relatively cheap manufacturing and assembled costs, and at the very least, some embodiments offer the public a useful choice.

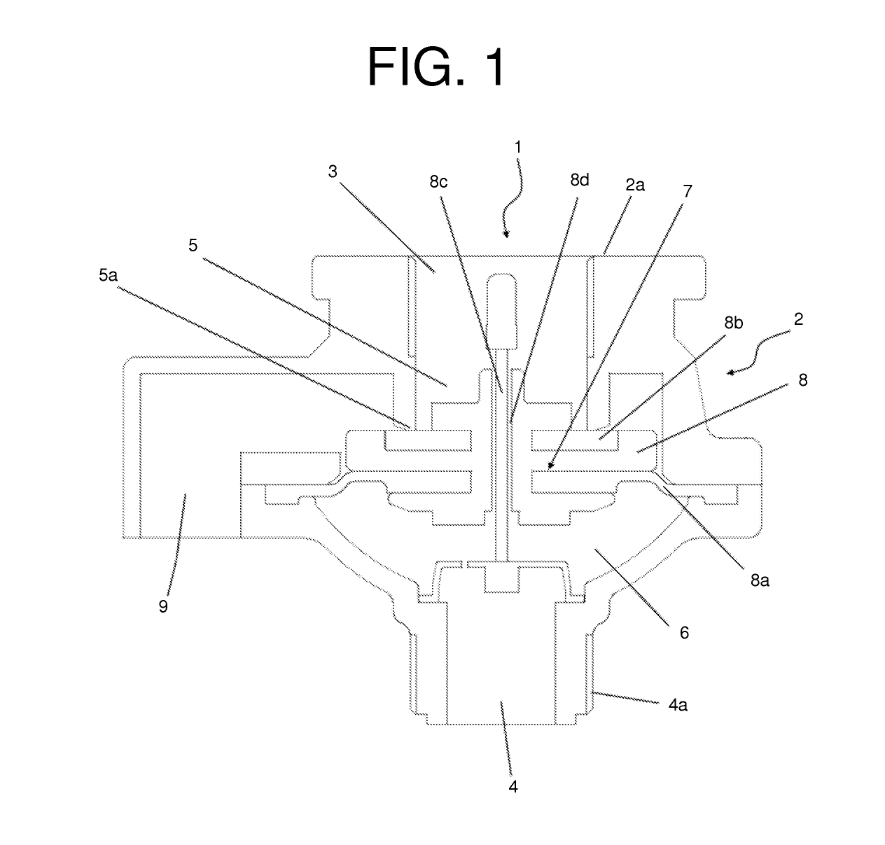

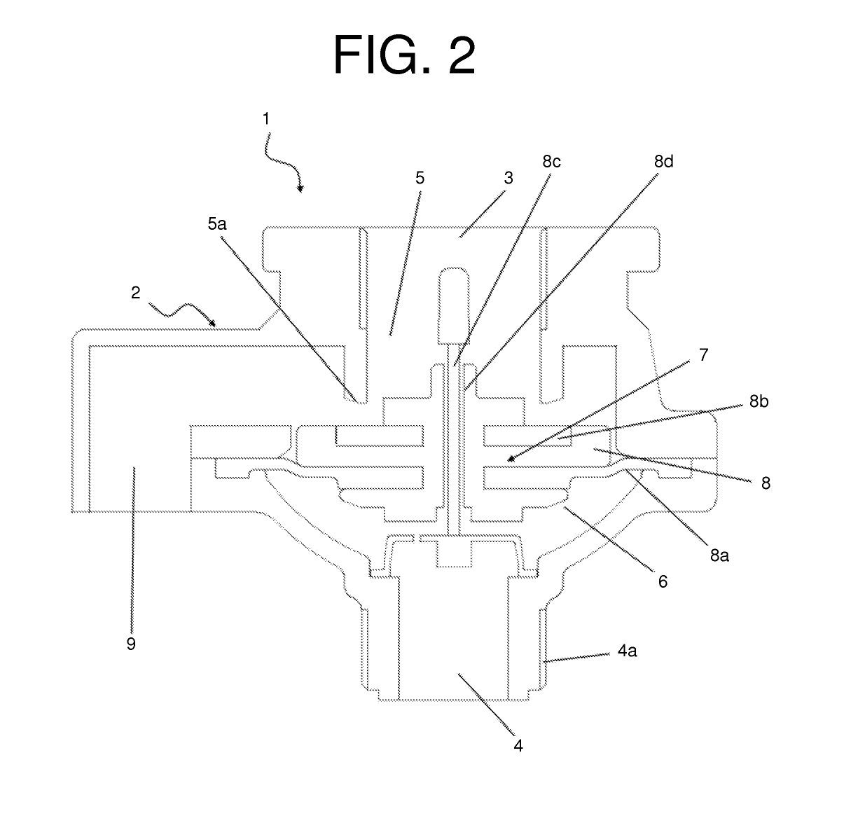

An attachment 1 is depicted in FIGS. 1 and 2. It consists of a body 2 with an inlet 3, positioned on the upper side 2a of the body 2, for water entering the body 2, and a first outlet 4 for water exiting the body 2.

The first outlet 4 is provided with a thread 4a, which serves as an attachment point for the body 2 to the float valve (not shown) with which attachment 1 may be used. Likewise, the inlet 3 is threaded or otherwise configured for use with a water supply (not shown).

It will be seen that internally, the body 2 has an upper compartment 5 and a lower compartment 6, partially defined and substantially separated by a valve mechanism 7 which includes a hub assembly 8.

The valve mechanism 7 is anchored at its center via the hub assembly 8, which includes a valve diaphragm 8a configured to allow movement of the hub assembly 8 in a vertical orientation. The valve mechanism 8a is key to some embodiments and is operable via water pressure differences between the upper compartment 5 and lower compartment 6.

When the water pressure on the downstream side of the valve mechanism 7 is equal to or greater than that on its upstream side, as depicted in FIG. 1, the valve diaphragm 8a is in a closed position, and the seal 8b of the valve mechanism 7 is biased against the interior surface 5a of the upper compartment 5. The interior surface 5a acts as a seat for the valve mechanism 7.

This prevents significant water flow from passing from the water supply (not shown) through the body 2 and into the float valve (not shown) with which attachment 1 is to be used. This would be the situation that would occur when the ballcock of the float valve is biased against its outlet. This means that the trough (not shown) is full, and does not require replenishment.

In this embodiment, the central shaft 8c of the hub assembly 8 is dimensioned such that it is slightly smaller than the sleeve 8d through which it passes. If the lower compartment 6 of the body 2 is not already full, then this will allow a trickle of water through.

However, should water levels in the trough (not shown) decline, the float drops away from the outlet of the float valve (not shown). This reduces the pressure under the valve mechanism 7, meaning the pressure differential biases the valve mechanism 7 open and deforms the valve diaphragm 8a. This unseals the valve, allowing water to flow through the body 2. The valve in this scenario is positioned as illustrated in FIG. 2.

As well as water exiting the outlet 4, the water is also able to exit the body 2 via a second outlet 9, which may be considered to be an overflow port. When the valve mechanism 7 is closed, this second outlet 9 is associated with the lower compartment 6. Therefore, when the water pressure is equal between the upper compartment 5 and lower compartment 6, no water can pass through the second outlet 9.

The second outlet 9 is dimensioned such that a greater amount of water is able to exit it than through the outlet of the float valve (not shown). This helps replenish the trough at a greater flow rate than what is possible through the use of the float valve alone.

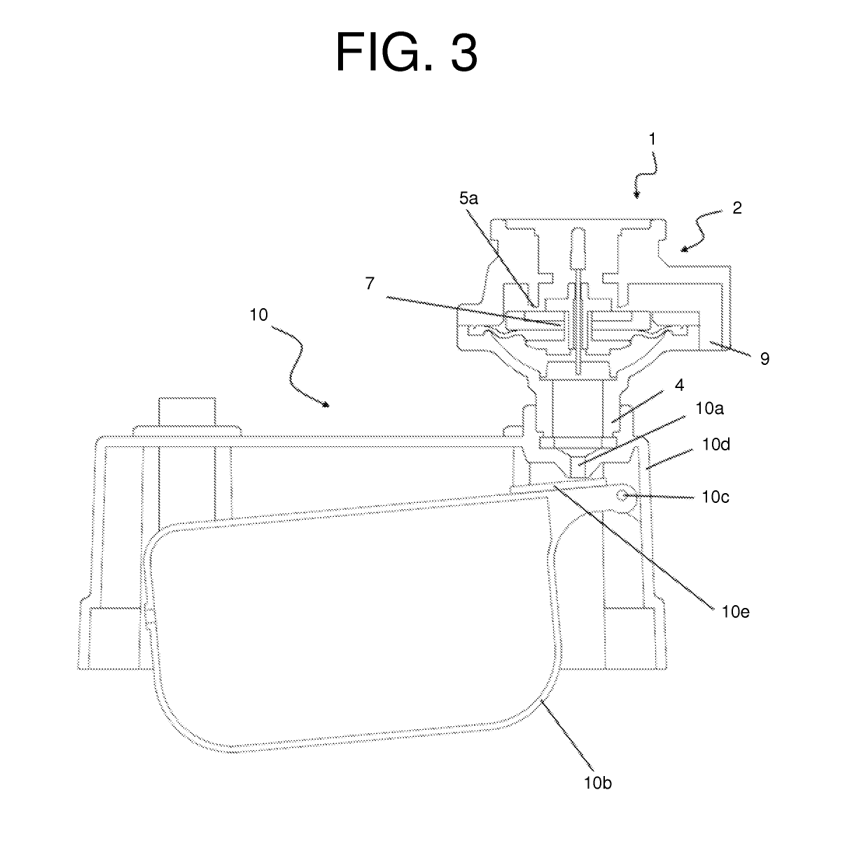

Turning now to FIG. 3, attachment 1 is shown in use with a float valve 10. The float valve includes an inlet 10a, into which the first outlet 4 of the body 2 of attachment 1 is fitted. The float valve 10 also includes a ballcock 10b, which is essentially a buoy, anchored at one end to a pivot point 10c provided on an interior wall of a housing 10d.

A portion 10e of the upper side of the ballcock 10b normally biases against the inlet 10a when the trough (not shown) is full, preventing water flow. However, it will be appreciated that as the water level in the trough decreases, the ballcock 10b falls downward as illustrated. This opens up the inlet 10a of the float valve 10. This in turn reduces the pressure within the lower compartment 6 of the body 2, and the valve mechanism 7 falls away from its seat 5a. Water is able to follow through the body into the trough through the first outlet 4 and second outlet 9 of the body 2.

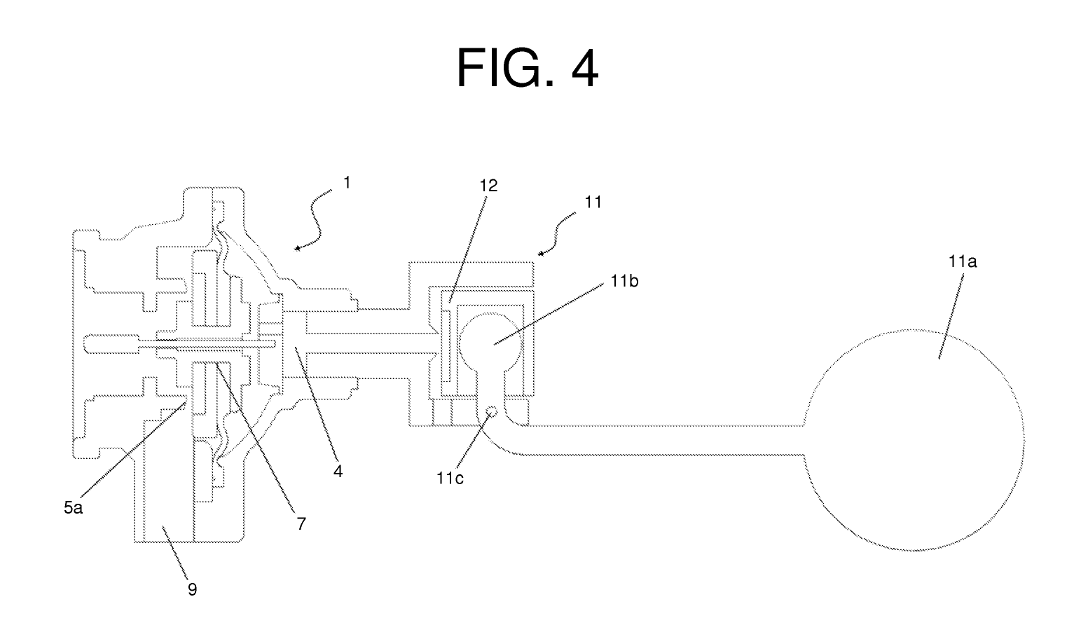

FIG. 4 shows the attachment 1 in use with a second type of float valve 11. The ballcock 11a is mounted to a lever or arm 11b which rotates about a pivot point 11c with changes in water level to act against a plunger mechanism 12 in order to close or open the float valve. The principle of operation remains the same. If the ballcock 11a falls away as the water levels in the trough (not shown) decreases, attachment 1 acts to allow water flow through both the first outlet 4 and second outlet 9 (shown here orientated directly downwards without the elbow bend of the previous figures).

As the ballcock 11a rises, the pressure on the downstream side of the valve mechanism 7 becomes greater than the water pressure on the upstream side of the valve mechanism 7, thereby forcing it against its seat 5a. This stops further water flow.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. An attachment for a float valve, comprising:
a body, wherein the body comprises an upper compartment and a lower compartment;
an inlet associated with the upper compartment;
a first outlet associated with the lower compartment; and
a valve configured to close the inlet when used, wherein
the first outlet is configured to engage with an inlet of a float valve, and the body comprises a second outlet that, when in use, is configured to be sealed by the valve when the valve closes the inlet associated with the upper compartment.

2. The attachment of claim 1, wherein the body is formed from an upper half and a lower half.

3. The attachment of claim 2, wherein the upper compartment is at least partially defined by the upper half of the body and the lower compartment is at least partially defined by the lower half of the body.

4. The attachment of claim 1, wherein the inlet is defined at least partially by the upper compartment.

5. The attachment of claim 1, wherein the inlet is the upper compartment.

6. The attachment of claim 1, wherein the inlet is configured to mate with an end of a water pipe or hose.

7. The attachment of claim 1, wherein the inlet is configured to mate with a fitting attached to an end of a water pipe or hose.

8. The attachment of claim 1, wherein a portion of the upper compartment is configured as a seat for the valve.

9. The attachment of claim 8, wherein the seat is a flat ring-like structure depending downwards from the opening of the inlet into the interior of the body.

10. The attachment of claim 9, wherein the valve comprises an upstream side and a downstream side.

11. The attachment of claim 10, wherein at least a portion of the surface of the upstream side of the valve seals against the seat.

12. The attachment of claim 10, wherein the valve comprises a hub assembly.

13. The attachment of claim 12, wherein the hub assembly comprises a surface that seals against the seat.

14. The attachment of claim 10, wherein the valve comprises a deformable diaphragm.

15. The attachment of claim 14, wherein outer edges of the valve diaphragm are sandwiched between the upper and lower compartments.

16. The attachment of claim 1, wherein the second outlet is configured to extend to a side of the body.

17. The attachment of claim 1, wherein the second outlet is communicative with the upper compartment when the valve is in an open position.

18. A method of installing an attachment to a float valve comprising an inlet, comprising:
fitting the attachment to the inlet of the float valve by connecting a first outlet of the attachment to the inlet of the float valve.

19. A float valve, comprising:
a first inlet; and
an attachment, wherein the attachment comprises:
a body, wherein the body comprises an upper compartment and a lower compartment;
a second inlet associated with the upper compartment;
a first outlet associated with the lower compartment; and
a valve configured to close the second inlet when used, wherein
the first outlet is configured to engage with the first inlet, and the body comprises a second outlet that, when in use, is configured to be sealed by the valve when the valve closes the second inlet.

20. A kitset of parts for a float valve, comprising:
an attachment for a float valve; and
a float valve, wherein the float valve comprises an inlet, the attachment comprising:
a body, wherein the body comprises an upper compartment and a lower compartment;
a second inlet associated with the upper compartment;
a first outlet associated with the lower compartment; and
a valve configured to close the second inlet when used, wherein
the first outlet is configured to engage with the first inlet, and the body comprises a second outlet that, when in use, is configured to be sealed by the valve when the valve closes the second inlet.
